(19) United States
(12) Patent Application Publication
(10) Pub. No.: US 2018/0189457 A1
(43) Pub. Date: Jul. 5, 2018

(54) Dynamic Search and Retrieval of Questions

(71) Applicant: Universal Research Solutions, LLC, Columbia, MO (US)

(72) Inventors: Otho Raymond Plummer, Columbia, MO (US); Ali Adel Hussam, Columbia, MO (US)

(21) Appl. No.: 15/395,902

(22) Filed: Dec. 30, 2016

(51) Int. Cl. G06F 19/00; G06N 99/00

(52) U.S. Cl. CPC G06F 19/3443; G06N 99/005

(57) ABSTRACT

A method includes actions of accessing a database storing multiple forms of a particular type that are each associated with a score. The actions include obtaining data corresponding to one or more forms from the database storing forms that includes at least (i) one or more questions, (ii) one or more answers to the one or more questions, and (iii) a score, training a machine learning model hosted by a server, wherein training the machine learning model includes: processing the data corresponding to the one or more forms from the database storing forms into a plurality of clusters, and for each cluster, identifying a subset of questions, from the predetermined number of questions, that are uniquely associated with each cluster, and generating a dynamic question identification model based on the identified subset of questions for each cluster.

### FIELD

This specification is generally related to search and retrieval of questions.

### BACKGROUND

Databases can be used to store large quantities of information related to entities. When analyzed in isolation, each particular record in the database may not provide much information. However, when such information is analyzed to identify trends, relationships, or the like, hiding amongst the data, powerful inferences may be made based on the identified trends, relationships, or the like.

### SUMMARY

According to one innovative aspect, the subject matter of this specification may be embodied in a method for dynamically searching for and retrieving a question. The method may include the actions of accessing, by a server, a database storing multiple medical instruments that are each associated with a medical instrument score and a medical instrument type, wherein each medical instrument type includes a predetermined number of questions, obtaining, by the server, data corresponding to one or more medical instruments of a particular type from the database storing medical instruments, wherein the data corresponding to the one or more medical instruments includes at least (i) one or more questions, (ii) one or more answers to the one or more questions, and (iii) a medical instrument score, training a machine learning model hosted by the server, wherein training the machine learning model includes: processing, by the machine learning model, the obtained data corresponding to the one or more medical instruments into a plurality of clusters, and for each cluster, identifying, by the machine learning model, a subset of questions and corresponding answers, from the predetermined number of questions, that are uniquely associated with each cluster, and generating, by the machine learning model, a dynamic question identification model based on the identified subset of questions for each cluster.

Other versions include corresponding systems, apparatus, and computer programs to perform the actions of methods, encoded on computer storage devices.

These and other versions may optionally include one or more of the following features. For instance, in some implementations, training the machine learning model may include processing, by the machine learning model, the obtained data corresponding to each particular medical instrument of the one or more medical instruments into a plurality of clusters based on a medical instrument score that is associated with the particular medical instrument, for each cluster, identifying, by the machine learning model, a subset of questions and corresponding answers, from the predetermined number of questions, that is uniquely associated with the particular cluster, and iteratively performing, by the machine learning model, the processing and analyzing steps until a predetermined termination criterion is satisfied.

In some implementations, the predetermined termination criterion may be satisfied when each cluster of the plurality of clusters include a number of medical instruments that exceeds a minimum threshold number of medical instruments.

In some implementations, training the machine learning model may include: processing, by the machine learning model, the obtained data corresponding to each particular medical instrument of the one or more medical instruments into a plurality of clusters based on a medical instrument score associated with a second medical instrument that is related to the particular medical instrument, for each cluster, identifying a subset of questions and corresponding answers from the predetermined number of questions associated with the one or more medical instruments that is uniquely associated with the particular cluster, and iteratively performing, by the machine learning model, the processing and analyzing steps until a predetermined termination criterion is satisfied.

In some implementations, generating a dynamic question identification model based on the identified subset of questions for each class may include generating a hierarchical decision tree.

In some implementations, the hierarchical decision tree may include at least one path from a root node to a leaf node for each cluster of the plurality of clusters, wherein each path may include one or more intervening nodes, wherein the root node and each intervening node may each be associated with a question, wherein each leaf node is associated with a particular cluster.

In some implementations, the sum of the root node and each intervening node for each path from the root node to any one of the leaf nodes may be less than the predetermined number of questions associated with the particular type of medical instrument.

In some implementations, the method may also include providing, by the dynamic question identification model, a question for display on a user device, receiving, by the dynamic question identification model, an answer to the question from the user device, dynamically generating, by the dynamic question identification model, a subsequent question based at least in part on the answer received from the user device, and providing, by the dynamic question identification model, the subsequent question for display on the user device.

The subject matter disclosed by this specification provides multiple advantages over conventional methods. For instance, the subject matter disclosed by this specification improves data integrity of the data obtained from questionnaires by obtaining information from a user using less than all questions associated with a particular questionnaire. Using less questions to obtain questions from a user helps keep the user engaged for a shorter period of time, thereby improving the integrity of the received data responsive to the questionnaire. In addition, the system and methods described herein provide for training a machine learning model in order to increase the accuracy of the machine learning model's predictions with respect to future treatment options.

### BRIEF DESCRIPTION OF THE DRAWINGS

FIG. 1 is a diagram of an example of system for generating a dynamic question identification model.

FIG. 2 is a flowchart of an example of a process for generating a dynamic question identification model.

FIG. 3 is a flowchart of an example of a process for training a dynamic question identification model.

FIG. 4 is a diagram of another example of a system for training a dynamic question identification model to facilitate predictive modeling.

FIG. 5 is a flowchart of another example of a process for training a dynamic question identification model to facilitate predictive modeling.

FIG. 6 is a contextual diagram of an example of a run-time implementation of a dynamic questionnaire application.

FIG. 7 is a block diagram of an example of a decision tree that may be used by a dynamic question identification model.

### DETAILED DESCRIPTION

In some implementations, the present disclosure provides a dynamic question identification model. The dynamic question identification model facilitates identification of a subset of questions associated with a particular medical instrument (e.g., a form or questionnaire), which can be used to obtain data from a patient. Then, a patient score may be generated, based on the obtained data, and used to classify the patient into a particular class.

The approach provided by this specification is advantageous because it facilitates generation of a patient score based on a particular medical instrument without requiring the patient to answer all the questions associated with the particular medical instrument. Since less than all questions associated with a particular medical instrument are read, and responded to, the patient can complete the medical instrument administered using the dynamic question identification model in less time than the patient could complete all of the questions associated with the medical instrument.

Moreover, the reduced amount of time required to complete a medical instrument administered using the dynamic question identification model improves the quality of the data obtained from the patient because the patient completes an identified subset of necessary questions with a higher level of engagement than the user would have if the user needed to read and complete every question of the questionnaire. Though the patient is answering less than all of questions associated with a medical instrument, the patient score generated using the subset of questions identified by the dynamic question model is substantially the same as the patient score that would be generated if the patient read, and provided a response to, every question associated with the particular medical instrument.

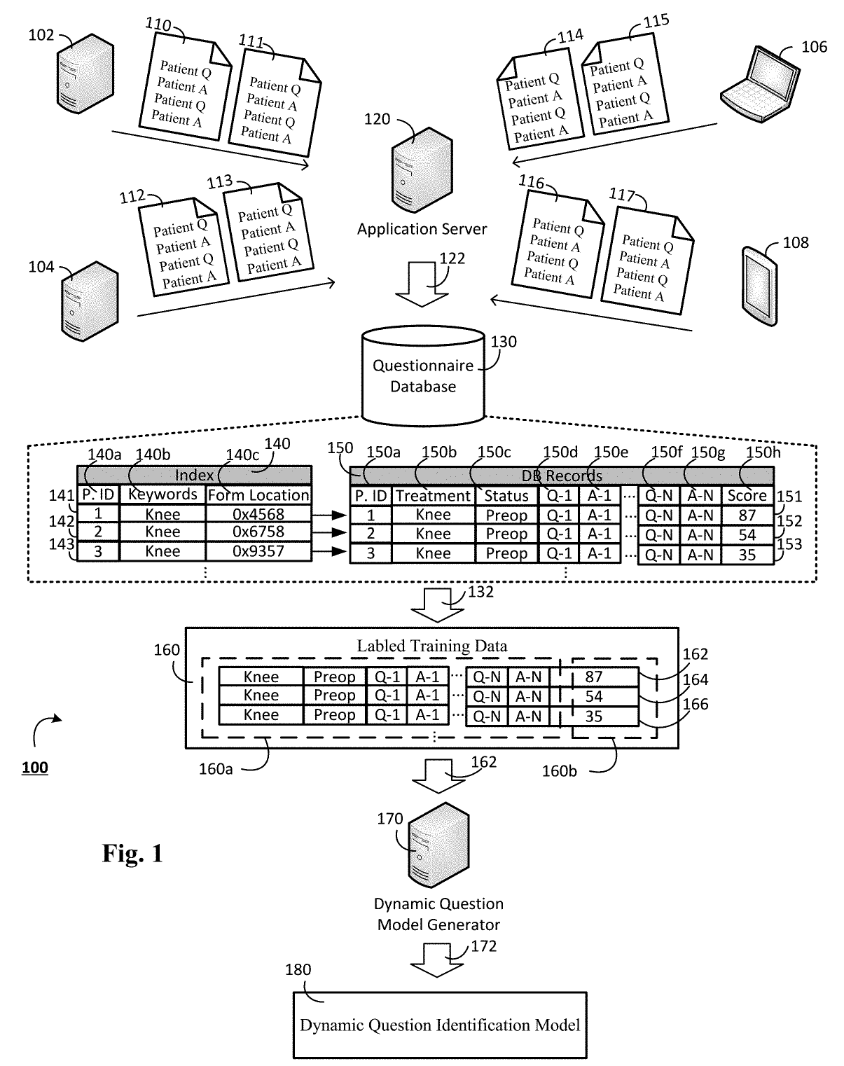

FIG. 1 is a diagram of an example of system 100 for generating a dynamic question identification model. The system 100 includes at least an application server 120, a questionnaire database 130, and a dynamic question identification model generator 170.

The application server 120 includes one or more computing devices that are configured to receive documents from one or more remote computers. In some implementations, the received documents may include medical instruments such as patient questionnaires 110, 111, 112, 113, 114, 115, 116, 117. The remote computers may include, for example, a server (or other computer) 102 at a physician's office that provides questionnaires that the physician's patients have completed, a third party server (or other computer) 104 that aggregates completed questionnaires completed by patients of multiple different physicians, or client computers 106, 108 that belong to particular patients that have used a client computer such as client computers 106, 108 to complete and transmit a questionnaire. Each remote computer 102, 104, 106, 108 may provide one or more patient questionnaires to the application server 120 using one or more networks such as a LAN, a WAN, a cellular network, the Internet, or a combination thereof.

The application server 120 may include a data extraction unit that is configured to receive patient questionnaires. The data extract unit may be configured to process the received patient questionnaires, and store 122 the received patient questionnaires in a database such as questionnaire database 130. The questionnaire database 130 may include any type of database such as a relational database, hierarchical database, unstructured database, or the like that allows for the storage and retrieval of the received patient questionnaires.

Storage of the received patient questionnaires may include generating an index 140 that can be used to access one or more database records 150 that each correspond to a particular received questionnaire. A generated index 140 may include an index entry such as index entries 141, 142, 143 for each received patient questionnaire. Each index entry may include, for example, a patient identifier (e.g., P. ID) 140a, one or more keywords 140b extracted from a received questionnaire, and a form location 140 that includes a reference to the storage location of the questionnaire identified by the index entry. By way of example, the index entry 141 stores a P. ID of “1,” a keyword “knee,” and a reference to a storage location such as a memory location “0x4568” that points to a database record 151 of a particular questionnaire that the index entry 141 is associated with.

The questionnaire database 130 may store data from each received questionnaire that was extracted by the data extraction unit hosted by the application server. Each database record such as database records 151, 152, 153 may correspond to a particular patient questionnaire that was received by the application server 120. Alternatively, multiple different database records may be used to store data that corresponds to a particular patient questionnaire. Patient questionnaire data stored in the patient questionnaire database 130 may include, for example, a patient identifier (e.g., P. ID) 150a, a treatment type 150b, a treatment status 150c, a questions 150d, 150f from the questionnaires, answers 150e, 150g that were provided by patients in response to respective questions 150d, 150f from the questionnaires, and a patient score 150h. The patient database 130 may store up to N question-answer pairs from each respective questionnaire, where N is any positive integer.

The score 150h may be a value determined by the application server 120, or other computer, based on an analysis of a completed, or partially completed, patient questionnaire. The score 150h may be used to classify a patient that is associated with a particular patient questionnaire into a particular class of patients. In some implementations, classifications of patients may be based on, for example, ranges of patient scores. For example, patients that completed questionnaires that have a patient score of 0-25 may be indicative of patients rated “below average,” patients that have completed questionnaires that have a patient score of 26-74 may be rated “average,” and patients that have completed questionnaires that have a patient score of 75-100 may be rated as “above average.” Such classifications may be used to determine, for example, the status of a patient's health, response to treatment, suitability for a treatment, or the like. Though the example above provides patient scores that are integer numbers between 0 and 100, the present disclosure need not be so limited. For instance, patient scores may also range between 0 and 1 (e.g., 0.12, 0.26, 0.85, and the like). Alternatively, patient scores may also include letter grades such as “A,” “B,” “C,” “D,” and “F.” Yet other types of patient scores may also fall within the scope of the present disclosure.

Over time, the system 100 may accumulate and store accumulate vast amounts of questionnaires of different types from multiple different sources. For instance, the questionnaire database 130 may store functional questionnaires. Functional questionnaires may include, for example, questionnaires that inquire about a level of functionality associated with a patient's body such as the patient's knee, wrist, arm, back, foot, rotator cuff, or the like before or after a treatment related to the patient's body. A patient score for a functional questionnaire may therefore be indicative of a patient's level of functionality with respect to a particular body part. For instance, a functional questionnaire related to a “knee” procedure with a patient score of “54” may indicate that the patient associated with that questionnaire has an average use of the patient's knee. The database 130 may also store quality of life questionnaires. Quality of life questionnaires may include, for example, questionnaires that inquire about a patient's quality of life before or after a patient treatment. For instance, a patient score of “88” for a quality of life questionnaire may indicate that the patient associated with the questionnaire has an “above average” quality of life. The database 130 may also store patient satisfaction questionnaires. Patient satisfaction questionnaires may include, for example, questionnaires that inquire about a patient's level of satisfaction after a patient treatment received from a physician. For instance, a patient score of “23” for a patient satisfaction questionnaire may indicate that the patient had a below average level of satisfaction after receiving treatment from a physician. Yet other types of questionnaires may be stored by the questionnaire database 130.

For purposes of this specification it is noted that how the patient score is determined for each received questionnaire is not limited to any particular patient score calculation. Instead, any method known in the art for determining a patient score based on patient answers provided in response to a patient questionnaire may be used to calculate the patient score. Similarly, though example categories of “below average,” “average,” and “above average” are described, the present disclosure need not be so limited. For instance, other example categories may be determined based on ranges of patient scores such as “unhealthy,” “healthy,” or the like. Alternatively, categories may be indicative whether past treatment, potential treatment, or the like was, or is likely to be, “successful,” “unsuccessful,” or the like.

The questionnaire data stored in the questionnaire database 130 may be obtained 132, and used to generate a set of labeled training data 160. The set of labeled training data 160 includes multiple labeled training data items 162, 164, 166. Each labeled training data item 162, 164, 166 includes a training data item 160a such as data extracted from a questionnaire. The training data items 160a may include data extracted from a particular type of questionnaire including, for example, at least the set of N questions and N answers associated with a particular questionnaire type. For example, the labeled training data 160 in the example of FIG. 1 includes data from functional questionnaires related to a patient's knee. The label 160b for each labeled training data item 162, 164, 166 may include the patient score that is associated with the questionnaire from which the labeled training data item was derived.

The labeled training data 160 is used to train 170 a dynamic question identification model generator 170. For example, the labeled training data 160 is provided as an input to the dynamic question identification model generator 170. The dynamic question identification model generator 170 may use one or more machine learning algorithms such ID3, C4.5, C5.0, or the like to process the labeled training data 160 and generate a dynamic question identification model 180. The processing of the labeled training data 160 by the dynamic question identification model generator 170 may include clustering the training data items into two or more different clusters based on the patient scores associated with the questionnaires corresponding to each respective training data item. Then, each respective cluster of questionnaires may be analyzed using the one or more machine learning algorithms to identify patterns in the question and answer pairs associated with questionnaires in the cluster. A question and answer pair may include, for example, a question from a questionnaire and the answer provided in response to the question by a patient, representative of the patient, or the like.

By way of example, dynamic question identification model generator 170 can process the labeled training data 160 in an effort to identify questions and patterns in the labeled training data 160 until the dynamic question identification model generator 170 can determine that all, or in other implementations a predetermined threshold amount that is less than all, of the questionnaires associated with cluster “A” included a question #1 associated an answer X, a question #3 associated with an answer Y, and a question #7 associated with an answer Z, where X, Y, and Z are answers to respective questions #1, #3, #7. Accordingly, the dynamic question identification model generator 170 can generate a dynamic question model that need only provide the subset of questions #1, #3, #7 of the questionnaire which may include, for example 15 questions, to determine whether a patient should be classified into cluster “A.” The dynamic question identification model generator 170 may perform a similar analysis for each cluster of questionnaires clustered based on a received set of labeled training data 160.

Identifying patterns to questions associated with questionnaires in a cluster may include, for example, detecting a minimum subset of questions and answers in a set of clustered questionnaires that is common amongst each of the questionnaires associated with the cluster. Alternatively, or in addition, a common subset of questions and answers may be selected once the dynamic question identification model generator 170 determines that the set of common questions uniquely identifies questionnaires that are uniquely associated with the cluster. In some implementations, the dynamic question identification model generator may continue iteratively processing the labeled training data 160 until a predetermined criterion is satisfied. A predetermined criterion may include, for example, identification of two or more clusters of questionnaires that (i) each include more than a predetermined minimum number of questionnaires, and (ii) are each associated with a subset of questions and answers from the questionnaire that are uniquely associated with the cluster.

In some implementations, the answers X, Y, and Z may be integer numbers that fall on a scale of between 0 and 10 that are each indicative of the patient's response to a question. In such implementations, identification of a pattern may be based on whether all, or a predetermined, number of questionnaires in a cluster include answers to one or more questions that fall within a predetermined numerical range. For instance, for integer answers falling on a scale between 0 and 10, answers between 0-3 may be determined to be the same, answers between 3-6 may be determined to be the same, and answers between 7-10 may be the same. However, the present disclosure should not be limited answers falling within a numerical range, numerical answers, or the like. Instead, any type of answer may be provided in response to a questionnaire including, for example, text string answers including one or more words, true/false answers, or the like.

The result 172 of training a dynamic question identification model generator 170 is a dynamic question identification model 180. The dynamic question identification model 180 can be used to implement a dynamic questionnaire that selects questions from a pool of questions associated with a particular questionnaire based on interaction with a user. In some implementations, the dynamic question identification model 180 may include a decision tree that begins with a root node related to a particular initial question, and also include two or more paths that lead to respective leaf nodes associated with a particular classification. Each path from the root node to a leaf node may be based on a subset of questions identified as being uniquely associated with a cluster of questionnaires. For example, one path from the root node to a leaf node may be based on a subset of questions uniquely associated with a “below average” patient score, a second path from the root node to a leaf node may be based on a subset of questions identified as being uniquely associated with an “average” patient score, a third path from the root node to a leaf node may be based on a subset of questions identified as being uniquely associated with an “above average” patient score, and the like. The root node of the decision tree and intervening nodes of the decision tree between the root node and each leaf node may be associated with a particular question. Branches that extend from each root node or each intervening node may be associated with an answer to the question associated with the root node or the intervening node. Then, each leaf node may be associated with a particular cluster, classification, or group such as “below average patients,” “average patients,” “above average patients,” or the like.

In some implementations, the dynamic question identification model 180 may be hosted by a server computer and made accessible to one or more client devices via a network such as a LAN, a WAN, a cellular network, or a combination thereof. Alternatively, the dynamic question identification model 180 may be provided over a network such as a LAN, a WAN, a cellular network, the Internet, or a combination thereof to a client device. Then, the client device may complete a dynamic questionnaire using the dynamic questionnaire model.

The dynamic question identification model 180 may then be made available to one or more patients having access to the server computer hosting the model or a client device where the model is installed. For example, a patient may be scheduled to have an upcoming knee surgery. As a result, the patient may submit a request to the pre-operation questionnaire. In some implementations, the dynamic question identification model 180 can be used to administer the pre-operation questionnaire. For example, the dynamic question identification model 180 can provide a first question to the patient. Then, based on the patient's answers to the question provided by the dynamic question identification model 180, the dynamic question identification model may generate a series of one or more additional questions that, taken together, will allow the dynamic question identification model to classify the patient into one of a plurality of classes such as “below average,” “average,” or “above average” based on the user's answers to the dynamically generated questions. In particular, the dynamic question identification model can classify the patient into a particular class such as the classes identified above by asking the patient less than all of the questions associated with a pre-operation knee questionnaire. In some implementations, the resulting patient class may be correlated to a patient score that is associated with the resulting patient class.

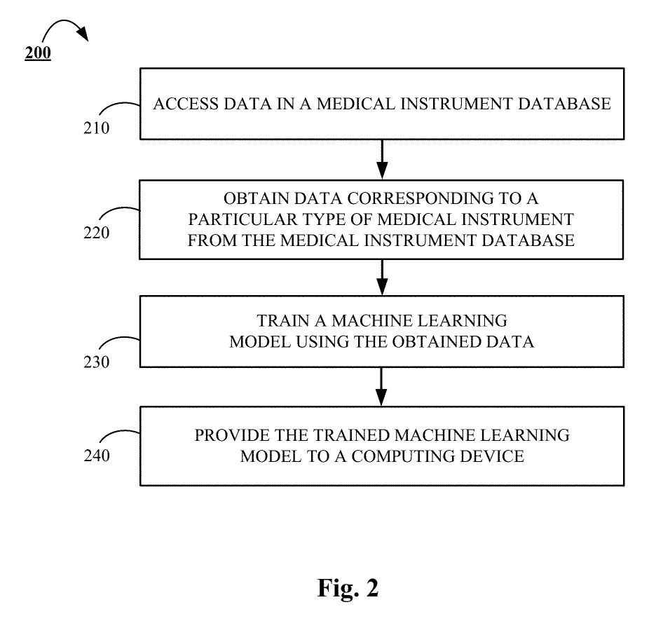

FIG. 2 is a flowchart of an example of a process 200 for generating a dynamic question identification model. The process 200 will be described below as being performed by a system of one or more computers such as system 100.

The system may access 210 data in a medical instrument database that is related to one or more medical instruments. The data in the medical instrument database may include records that each correspond to data extracted from a medical instrument. Each record may include, for example, a patient identifier, a treatment type, a treatment status, one or more question-answer pairs from a medical questionnaire, a patient score, or the like. The patient score may be calculated based on the patient's answers to the questions in a questionnaire completed by the patient.

The system may obtain 220 data corresponding to a particular type of medical instrument from the medical instrument database. For example, the system may obtain data related to a functionality questionnaire, a quality of life questionnaire, a patient satisfaction questionnaire, or the like. By way of further example, the system may obtain data that is related to a wrist functionality questionnaire. The obtained data may include data that is related to multiple different questionnaires of the same type. For each questionnaire of the same type, the obtained data may include at least a treatment type, a treatment status, one or more question-answer pairs from the questionnaire, and a patient score.

The system may use the obtained data to train 230 a machine learning model. The machine learning model may include, for example, ID3, C4.5, C5.0, or the like. Training the machine learning model may include, for example, providing the data obtained at stage 220 as an input to the machine learning model, which is configured to iteratively analyze the input. The machine learning model may process the labeled training data to identify one or more patterns in the question-answer pairs included within the questionnaires. The processing of the labeled training data by the dynamic question identification model generator 170 may include clustering the training data items into two or more different clusters based on patient score associated with the questionnaires corresponding to each respective training data item. Then, each respective cluster of questionnaires may be analyzed using the one or more machine learning algorithms to identify patterns in the question-answer pairs that uniquely identify each respective questionnaire as belonging to the cluster.

Once trained, the machine learning model may be provided 240 to a computing device that can facilitate execution of a dynamic questionnaire. The machine learning model may be provided to the computing device via one or more networks such as a LAN, a WAN, a cellular network, the Internet, or a combination thereof. The computing device may include a server device that makes the dynamic questionnaire available via a network such as a LAN, a WAN, a cellular network, the Internet, or a combination thereof. Alternatively, the computing device may include a client device that locally runs the dynamic questionnaire using a native application.

The trained machine learning model facilitates implementation of a dynamic questionnaire that selects questions from a pool of questions associated with a particular questionnaire based on user interaction. In some implementations, the dynamic question identification model may include a decision tree that begins with a root node related to a particular initial question, and then two or more paths that each lead to respective leaf node associated with a particular questionnaire classification.

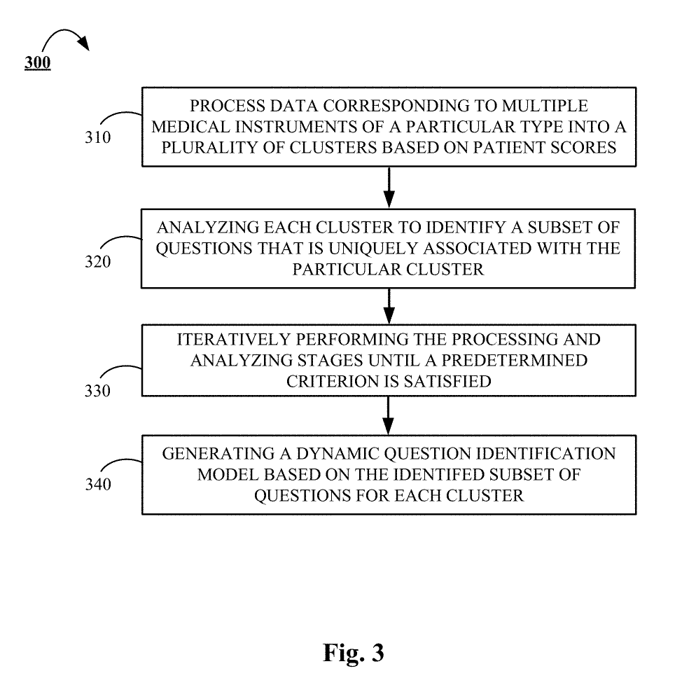

FIG. 3 is a flowchart of an example of a process 300 for training a dynamic question identification model. The process 300 will be described below as being performed by a system of one or more computers such as system 100.

The system may process 310 data corresponding to multiple medical instruments of a particular type into a plurality of clusters based on a patient score associated with each respective questionnaire. Then, the system may analyze 320 the questionnaires associated with each respective cluster using one or more machine learning algorithms such as ID3, C4.5, C5.0, or the like to identify patterns in the questions and answers associated with questionnaires in each respective cluster. Identifying patterns to questions associated with questionnaires in the cluster may include, for example, detecting a minimum subset of questions and answers in a set of clustered questionnaires that is common amongst each of the questionnaires associated with the cluster. Alternatively, or in addition, the minimum subset of common questions and answers may be selected once the dynamic question identification model generator determines that the set of common questions uniquely identifies questionnaires that are uniquely associated with the cluster.

The system may iteratively perform 330 the processing 310 and analyzing 320 stages until a predetermined criterion is satisfied. A predetermined criterion may include, for example, identification of two or more clusters of questionnaires that (i) each include more than a predetermined minimum number of questionnaires, and (ii) are each associated with a subset of questions and answers from the questionnaire that are uniquely associated with the cluster.

A dynamic question identification model may be generated 340 based on the identified pattern of question-answer pairs associated with each cluster. The dynamic question identification model facilitates implementation of a dynamic questionnaire that selects questions from a pool of questions associated with a particular questionnaire based on interaction with a user. In some implementations, the dynamic question identification model may include a decision tree that begins with a root node related to a particular initial question, and then two or more paths that lead to respective leaf node associated with a particular patient classification.

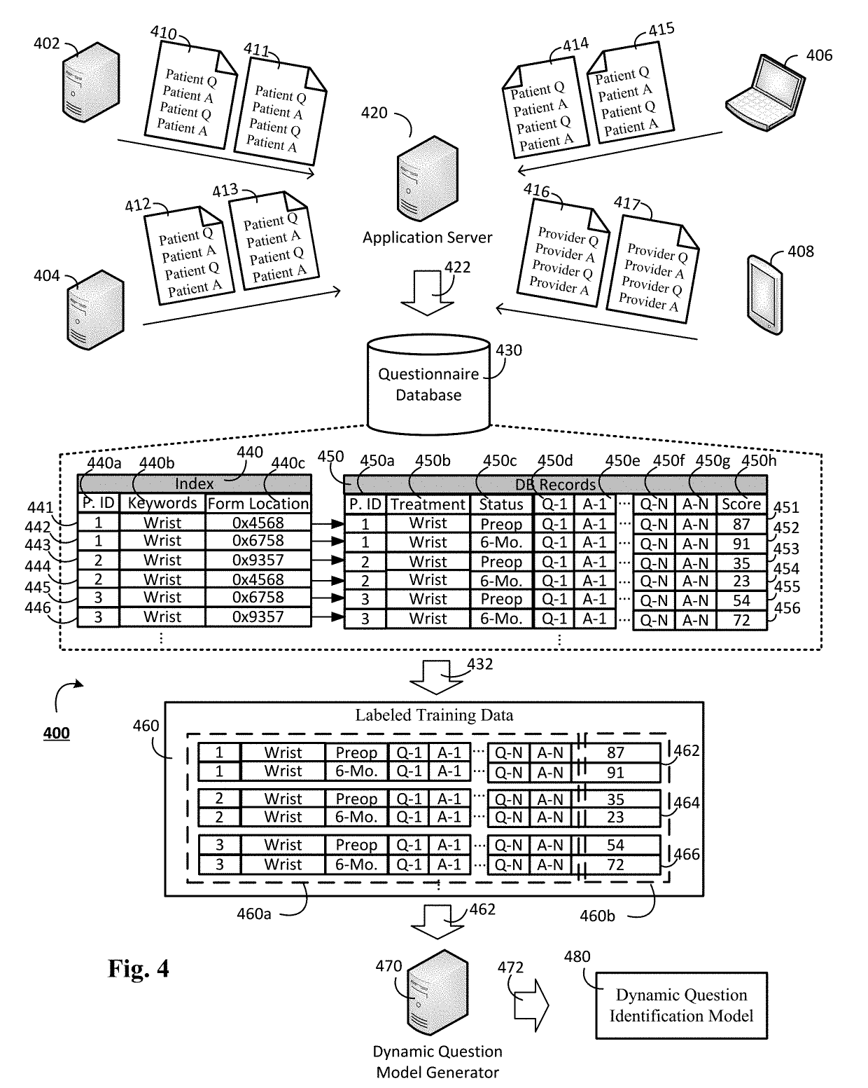

FIG. 4 is a diagram of an example of a system 400 for training a dynamic question identification model 480 to facilitate predictive modeling.

The system 400 is substantially similar to the system 100 described with reference to FIG. 1. For example, the application server 420 may perform the same functions as described with respect to the application server 120. The application server 420 may obtain patient questionnaires 410, 411, 412, 413, 414, 415, 416, 417 from remote computers 402, 404, 406, 408 in the same manner as application server 120 obtained patient questionnaires 110, 111, 112, 113, 114, 115, 116, 117 from remote computers 102, 104, 106, 108. The questionnaire database 430 may perform the same functions as described with respect to questionnaire database 130. For example, the questionnaire database 430 may receive 422 patient questionnaire data extracted by a data extractor hosted by the application server 420, generate an index 440 that can be used to access extracted patient questionnaire data when stored in the questionnaire database 430, and then store the patient questionnaire data for each respective patient questionnaire as one or more database records in the questionnaire database 430. However, in the example of FIG. 4, the questionnaire database 430 also provides an example of stored questionnaires that have different treatment statuses 450c for the same patient identifiers (e.g., P. ID) 450a. For example, the questionnaire database 430 may store a pre-op questionnaires for a particular patient and a 6-month post-op questionnaire for the same particular patient related to a wrist treatment.

Data stored in the questionnaire database 430 may be obtained and used as labeled training data 460 to train a dynamic question identification model generator 470. The labeled training data 460 includes training data 460a and label data 460b. In system 400, the labeled training data 460 used to train 462 a dynamic question identification model generator 470 may be grouped into pairs 462, 464, 466. Each pair of labeled training data 462, 464, 466 may include a pre-op questionnaire and a post-op questionnaire. The post-op questionnaire may include a 6-month post-op questionnaire, a 9-month post-op questionnaire, a 12-month post-op questionnaire, a 15-month post-op questionnaire, or the like.

The dynamic question identification model generator 470 may use one or more machine learning algorithms such ID3, C4.5, C5.0, or the like to process the pairs of labeled training data 460. The result 472 is a trained a dynamic question identification model 480. The processing of the labeled training data 460 by the dynamic question identification model generator 470 may include clustering the pairs of training data items 462, 464, 466 into two or more different clusters based on post-op scores such as 6-month post-op patient scores. Then, the pre-op questionnaires in each cluster of questionnaires pairs based on post-op scores may be analyzed using the one or more machine learning algorithms to identify patterns in the question and answer pairs associated with the respective pre-op questionnaires. Then, the dynamic question identification model generator 470 may use the identified pattern of questions and answers in the pre-op questionnaires as a set of questions that are indicative of a patient who will be categorized into a particular post-op classification that is associated with the cluster. The post-op classification may include, for example, “unsuccessful treatment,” moderately successful treatment,” or “highly successful treatment.”

The dynamic question identification model generator 470 can process the labeled training data 460 in an effort to identify questions and patterns in the pre-op questionnaires of labeled training data 460 that are associated with a particular cluster based on post-op scores. Each cluster based on post-op scores may be associated with a post-op classification such as “unsuccessful treatment,” “moderately successful treatment,” or “highly successful treatment,” or the like. The post-op clusters may be established based on ranges of post-op questionnaire scores such as 6-month post-op questionnaire scores. For example, a post-op questionnaire score of 0-30 may be an “unsuccessful treatment,” a post-op questionnaire score of 31-69 may be a “moderately successful treatment,” and a post-op questionnaire score of 70-100 may be a “highly successful treatment.” By way of example, the dynamic question identification model generator 470 can analyze the question and answer pairs associated with pre-op questionnaires that are associated with a particular post-op score cluster until the dynamic question identification model generator 470 can determine that all, or a predetermined threshold amount that is less than all, of the pre-op questionnaires associated with a particular post-op score cluster such as “highly successful” included a question #2 associated an answer S, a question #5 associated with an answer T, and a question #9 associated with an answer U, and a question #11 associated with an answer V, where S, T, U, and V are answers to respective questions #2, #5, #9, and #11.

Accordingly, the dynamic question identification model generator 470 generates a dynamic question model that need only provide the subset of questions #2, #5, #9, and #11 of the corresponding pre-op questionnaire which may include, for example 18 questions, to determine whether a patient should be classified into the post-op score cluster “highly successful.” The dynamic question identification model generator 470 may perform a similar analysis for each cluster of questionnaires generated based processing of the received pairs of labeled training data included in the labeled training data set 460. Such a subset of questions allows for the generation of a dynamic pre-op questionnaire that can facilitate predictive modeling of a medical treatment. For example, the dynamic pre-op questionnaire can result in a patient score that can be classified into a post-op of classification of “unsuccessful treatment,” “moderately successful treatment,” or “highly successful treatment” for a particular treatment. Accordingly, this allows a patient, physician, or the like to predict the outcome of a particular treatment in advance based on the answers a user provides to a pre-op questionnaire.

Identifying patterns to questions and answer pairs from pre-op questionnaires that are associated with a particular post-op score cluster includes, for example, detecting a minimum subset of question and answer pairs that are common amongst pre-op questionnaires completed by the same patient that is associated with a post-op patient score falling within a particular post-op score cluster. Alternatively, or in addition, a subset of questions and answers may be selected once the dynamic question identification model generator 470 determines that the set of common pre-op questionnaire questions uniquely identifies a particular post-op score cluster. In some implementations, the dynamic question identification model generator 470 may continue iteratively processing the pairs of labeled training data 460 until a predetermined criterion is satisfied. A predetermined criterion may include, for example, identification of two or more clusters of questionnaires that (i) each include more than a predetermined minimum number of questionnaires, and (ii) are each associated with a subset of questions and answers from pre-op questionnaires that are uniquely associated with a particular post-op score cluster.

The result 472 of training the dynamic question identification model generator 470 is a trained dynamic question identification model 480. The dynamic question identification model 470 facilitates implementation of a dynamic questionnaire that selects questions from a pool of questions associated with a particular pre-op questionnaire that is related to a particular post-op score cluster based user interaction. In some implementations, the dynamic question identification model 470 may include a decision tree that begins with a root node related to a particular initial question, and then two or more paths that lead to respective leaf node associated with a particular questionnaire classification. Each path from the root node to a leaf node may be based on a subset of questions identified as being uniquely associated with a cluster of questionnaires. For instance, one path from the root node to a leaf node may be based on the questions associated with a cluster of questionnaires associated with an “unsuccessful treatment” post-op score, a second path from the root node to a leaf node may be based on the questions associated with a cluster of questionnaires associated with a “moderately successful” post-op patient score, a third path from the root node to a leave node may be based on the questions associated with a cluster of questionnaires associated with an “highly successful” post-op patient score, and the like. The root node of the decision tree and intervening nodes of the decision tree between the root node and each leaf node may be associated with a question. Branches that extend from each root node or each intervening node may be associated with an answer to the question associated with the root node or the intervening node. Then, each leaf node may be associated with a particular cluster, classification, or group such as “unsuccessful treatment,” “moderately successful treatment,” “highly successful treatment” or the like.

In some implementations, the dynamic question identification model 480 may be hosted by a server computer and made accessible to one or more client devices via a network such as a LAN, a WAN, a cellular network, or a combination thereof. Alternatively, the dynamic question identification model 480 may be provided over a network such as a LAN, a WAN, a cellular network, the Internet, or a combination thereof to a client device. Then, the client device may complete a dynamic questionnaire using the dynamic questionnaire model.

The present disclosure need not be limited to a particular post-op questionnaire score such as a 6-month post op questionnaire score. For instance, other pairs of labeled training data may be obtained from the questionnaire database 430 and used to train the dynamic question identification model generator 470. For instance, other pairs of labeled training data that can be used to train the dynamic question identification model generator 470 may include pre-op and 1-month post-op, pre-op and 2-month post op, to pre-op and n-month post-op, where n is any non-zero integer. With such a system, a user could be presented with a timeline of post-op categories based on the user's completion of a single pre-op dynamic questionnaire. Thus, a patient, physician, or other user could look into the future, and be presented with a prediction as to how a patient will respond to a treatment 1 month, 2 months, 3 months, or n months into future. For example, the model may predict that, based on the patient's pre-op score, that the treatment may be highly successful for up to 12 months out from the treatment. However, the model may further predict that after 18 months out from treatment may become unsuccessful. As a result, the patient has the option of looking into the future, determining that the treatment is predicted to result in an adverse outcome, and decide not to have the treatment. Alternatively, the patient is at least provided with weighing the options of the patient's pre-treatment health against the user's predicted health a month, multiple months, or even years after the proposed treatment. For example, a patient could gauge the amount of pain the patient is currently in against the short term effects of the treatment, the long term effects of the treatment, and the like.

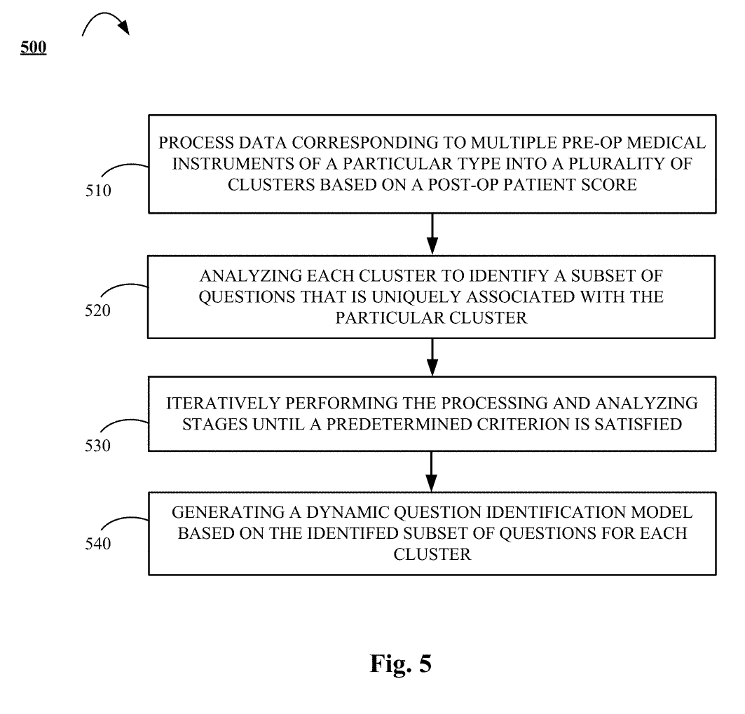

FIG. 5 is a flowchart of another example of a process 500 for training a dynamic question identification model to facilitate predictive modeling. The process 500 will be described below as being performed by a system of one or more computers such as system 400.

The system may process 510 pairs data corresponding to multiple pre-op medical instruments of a particular type into a plurality of clusters based on related post-op patient scores. A post-op score may be related to a pre-op medical instrument if the post-op score is generated based on a post-op score by the same user who completed the pre-op questionnaire. In some implementations, the processed data may include, for example, pairs of labeled training data.

Then, the system may analyze 520 the pre-op questionnaires associated with each respective cluster using one or more machine learning algorithms such as ID3, C4.5, C5.0, or the like to identify patterns in the questions and answers included in pre-op questionnaires that are related to a particular post-op score classification such as “unsuccessful treatment,” “moderately successful treatment,” “highly successful treatment,” or the like. Identifying patterns to questions and answer pairs from pre-op questionnaires that are associated with a particular classification of post-op scores include, for example, detecting a minimum subset of question and answer pairs that are common amongst pre-op questionnaires completed by the same patient that is associated with a post-op score falling within a particular category. Alternatively, or in addition, a subset of questions and answers may be selected once the dynamic question identification model generator determines that the set of common questions from pre-op questionnaires that uniquely identify a particular classification of post-op scores.

The system may iteratively perform 530 the processing 510 and analyzing 320 stages until a predetermined criterion is satisfied. A predetermined criterion may include, for example, identification of two or more clusters of questionnaires that (i) each include more than a predetermined minimum number of questionnaires, and (ii) are each associated with a subset of questions and answers from pre-op questionnaires that are uniquely associated with a particular classification of post-op scores.

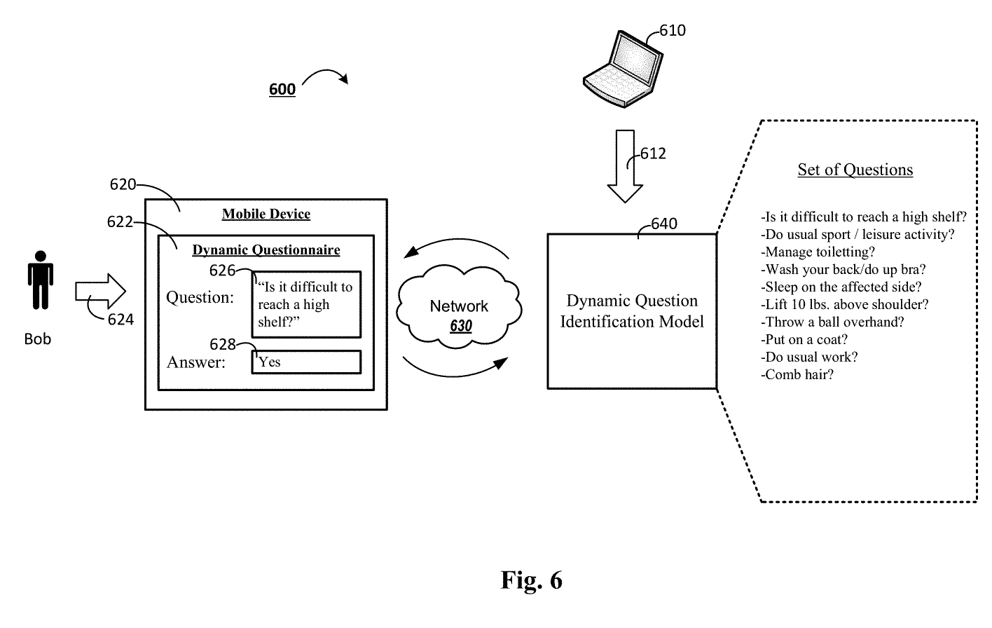

FIG. 6 is a contextual diagram of an example of a run-time implementation of a dynamic questionnaire application 622.

At run time, use of a dynamic questionnaire may begin with a computer 610 providing an instruction to the dynamic question identification model 640 to identify a particular questionnaire that should be used. For example, an input command 612 may be provided that instructions the dynamic question identification model 640 to administer a particular questionnaire. The computer 610 may be a computer associated with a physician, a computer associated with an insurance provider, a computer associated with the user Bob, or the like. Alternatively, the input command may be input using Bob's mobile device 620. In the example of FIG. 6, a functionality questionnaire related to the use of a rotator cuff is used. The rotator cuff questionnaire of this example includes 10 questions. However, because the dynamic question identification model 640 is trained to dynamically generate questions using machine learning techniques, the dynamic question identification model 640 can determine a patient score for the functionality of Bob's shoulder without asking all 10 questions.

The dynamic question identification model 640 may begin with the question corresponding to the root node of the decision tree generated during training. Once the command 612 is received, the dynamic questionnaire model 640 may load the questionnaire, and provide a user with the first question of the generated model such as a question corresponding to the root node of a decision tree. In the example of FIG. 6, the first question provided by the dynamic question identification model 640 over the network 630 to Bob's mobile device 620 is “Is it difficult to reach a high shelf?”. The question may be displayed in a text box 626 of a graphical user interface 622 provided on the display of Bob's mobile device 620. Bob may input his answer “Yes” into the text box 628 and submit the answer to the question, which the mobile device may transmit back to the dynamic question generation model 640. The dynamic question generation model 640 may select a subsequent question based on Bob's answer. For example, the next question selected based on the generated decision tree may be “Do usual sport/leisure activity?” Then the question is transmitted to Bob's mobile device, provided for display on Bob's mobile device, Bob inputs his answer, which is provided to the dynamic question generation unit 640.

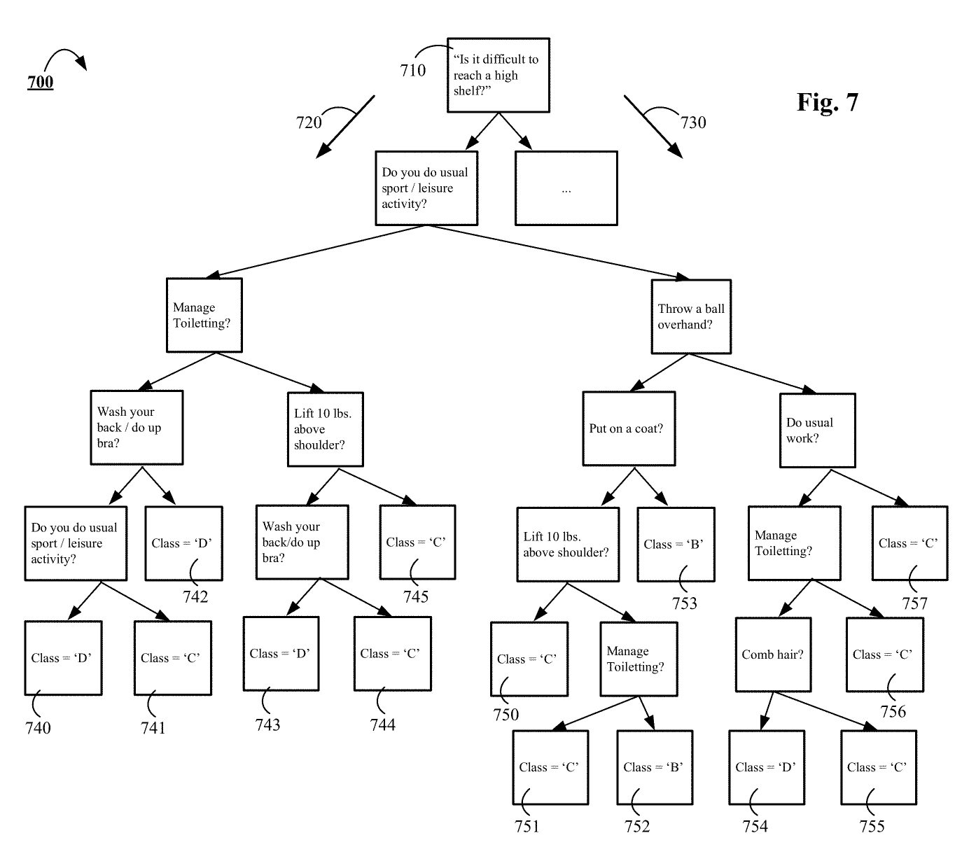

The aforementioned process may continue until Bob's responses to questions result in the traversal of an entire path of the decision tree from the root node to a leaf node generated during training. Once the decision tree is traversed to a leaf node, Bob can be classified based on the category associated with the leaf node. An example of a decision tree used by the dynamic question identification model 640 for a functional questionnaire related to a rotator cuff may include the decision tree 700 of FIG. 7.

FIG. 7 is a block diagram of an example of a decision tree 700 that may be used by a dynamic question identification model.

The decision tree 700 may include multiple nodes including a root node 710, multiple leaf nodes 740, 741, 742, 743, 744, 745, 750, 751, 752, 753, 754, 755, 756, 757, and multiple intervening nodes (e.g., all nodes in FIG. 7 that fall between the root node and the leaf nodes). The root node and each intervening nodes may each be associated with a particular question. Then, in response to the answer provided to the question associated with the node, the next question in the dynamic questionnaire sequence may be determined by following a first path 720 through the decision tree, a second path 730 through the decision tree, or the like. Each path through the decision tree from root node to a leaf (e.g., Class) node is determined during the iterative training process that identifies patterns of questions for each cluster of questionnaires.

The benefit of the decision tree 700 can be immediately identified based on a review of the decision tree. Though the example of the functionality questionnaire for a rotator cuff used in FIGS. 6 and 7 includes 10 questions, no path from the root node 710 to a leaf node 740, 741, 742, 743, 744, 745, 750, 751, 752, 753, 754, 755, 756, 757 requires asking all 10 questions. Instead, the decision tree constructed during training can classify a user into a particular category, cluster, group, type, or the like by asking a maximum of 6 questions.

Other examples may include questionnaires having more or less total questions, and training may result in dynamic questionnaires that ask less or more questions. However, implementations of the present disclosure provide a dynamic question identification model that improves the data integrity associated with questionnaire results. This is because, by asking less questions, the dynamic questionnaire encourages the user to be more engaged. That is, the shortened dynamic questionnaire can obtain necessary data from a user in a more efficient manner before the user becomes bored by completing a lengthy questionnaire.

Embodiments of the subject matter, the functional operations and the processes described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively, or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

1. A method, comprising:
accessing, by a server, a database storing multiple medical instruments that are each associated with a medical instrument score and a medical instrument type, wherein each medical instrument type includes a predetermined number of questions;
obtaining, by the server, data corresponding to one or more medical instruments of a particular type from the database storing medical instruments, wherein the data corresponding to the one or more medical instruments includes at least (i) one or more questions, (ii) one or more answers to the one or more questions, and (iii) a medical instrument score;
training a machine learning model hosted by the server, wherein training the machine learning model includes:
processing, by the machine learning model, the obtained data corresponding to the one or more medical instruments into a plurality of clusters, and
for each cluster, identifying, by the machine learning model, a subset of questions and corresponding answers, from the predetermined number of questions, that are uniquely associated with each cluster, and
generating, by the machine learning model, a dynamic question identification model based on the identified subset of questions for each cluster.

2. The method of claim 1, wherein training the machine learning model includes:
processing, by the machine learning model, the obtained data corresponding to each particular medical instrument of the one or more medical instruments into a plurality of clusters based on a medical instrument score that is associated with the particular medical instrument,
for each cluster, identifying, by the machine learning model, a subset of questions and corresponding answers, from the predetermined number of questions, that is uniquely associated with the particular cluster, and
iteratively performing, by the machine learning model, the processing and analyzing steps until a predetermined termination criterion is satisfied.

3. The method of claim 2, wherein the predetermined termination criterion is satisfied when each cluster of the plurality of clusters include a number of medical instruments that exceeds a minimum threshold number of medical instruments.

4. The method of claim 1, wherein training the machine learning model includes:
processing, by the machine learning model, the obtained data corresponding to each particular medical instrument of the one or more medical instruments into a plurality of clusters based on a medical instrument score associated with a second medical instrument that is related to the particular medical instrument,
for each cluster, identifying a subset of questions and corresponding answers, from the predetermined number of questions and corresponding answers associated with the one or more medical instruments that is uniquely associated with the particular cluster, and
iteratively performing, by the machine learning model, the processing and analyzing steps until a predetermined termination criterion is satisfied.

5. The method of claim 1, wherein generating a dynamic question identification model based on the identified subset of questions for each class includes generating a hierarchical decision tree.

6. The method of claim 5,
wherein the hierarchical decision tree includes at least one path from a root node to a leaf node for each cluster of the plurality of clusters,
wherein each path includes one or more intervening nodes, wherein the root node and each intervening node are each associated with a question,
wherein each leaf node is associated with a particular cluster.

7. The method of claim 6, wherein the sum of the root node and each intervening node for each path from the root node to any one of the leaf nodes is less than the predetermined number of questions associated with the particular type of medical instrument

8. The method of claim 1, further comprising:
providing, by the dynamic question identification model, a question for display on a user device;
receiving, by the dynamic question identification model, an answer to the question from the user device;
dynamically generating, by the dynamic question identification model, a subsequent question based at least in part on the answer received from the user device; and
providing, by the dynamic question identification model, the subsequent question for display on the user device.

9. A system comprising:
one or more computers and one or more storage devices storing instructions that are operable, when executed by the one or more computers, to cause the one or more computers to perform operations comprising:
accessing, by a server, a database storing multiple medical instruments that are each associated with a medical instrument score and a medical instrument type, wherein each medical instrument type includes a predetermined number of questions;
obtaining, by the server, data corresponding to one or more medical instruments of a particular type from the database storing medical instruments, wherein the data corresponding to the one or more medical instruments includes at least (i) one or more questions, (ii) one or more answers to the one or more questions, and (iii) a medical instrument score;
training a machine learning model hosted by the server, wherein training the machine learning model includes:
processing, by the machine learning model, the obtained data corresponding to the one or more medical instruments into a plurality of clusters, and
for each cluster, identifying, by the machine learning model, a subset of questions and corresponding answers, from the predetermined number of questions, that are uniquely associated with each cluster, and
generating, by the machine learning model, a dynamic question identification model based on the identified subset of questions for each cluster.

10. The system of claim 9, wherein training the machine learning model includes:
processing, by the machine learning model, the obtained data corresponding to each particular medical instrument of the one or more medical instruments into a plurality of clusters based on a medical instrument score that is associated with the particular medical instrument,
for each cluster, identifying, by the machine learning model, a subset of questions and corresponding answers, from the predetermined number of questions, that is uniquely associated with the particular cluster, and
iteratively performing, by the machine learning model, the processing and analyzing steps until a predetermined termination criterion is satisfied.

11. The system of claim 10, wherein the predetermined termination criterion is satisfied when each cluster of the plurality of clusters include a number of medical instruments that exceeds a minimum threshold number of medical instruments.

12. The system of claim 9, wherein training the machine learning model includes:
processing, by the machine learning model, the obtained data corresponding to each particular medical instrument of the one or more medical instruments into a plurality of clusters based on a medical instrument score associated with a second medical instrument that is related to the particular medical instrument,
for each cluster, identifying a subset of questions and corresponding answers, from the predetermined number of questions and corresponding answers associated with the one or more medical instruments that is uniquely associated with the particular cluster, and
iteratively performing, by the machine learning model, the processing and analyzing steps until a predetermined termination criterion is satisfied.

13. The system of claim 9, wherein generating a dynamic question identification model based on the identified subset of questions for each class includes generating a hierarchical decision tree.

14. The system of claim 13,
wherein the hierarchical decision tree includes at least one path from a root node to a leaf node for each cluster of the plurality of clusters,
wherein each path includes one or more intervening nodes, wherein the root node and each intervening node are each associated with a question,
wherein each leaf node is associated with a particular cluster.

15. A non-transitory computer-readable medium storing software comprising instructions executable by one or more computers which, upon such execution, cause the one or more computers to perform operations comprising:
accessing, by a server, a database storing multiple medical instruments that are each associated with a medical instrument score and a medical instrument type, wherein each medical instrument type includes a predetermined number of questions;
obtaining, by the server, data corresponding to one or more medical instruments of a particular type from the database storing medical instruments, wherein the data corresponding to the one or more medical instruments includes at least (i) one or more questions, (ii) one or more answers to the one or more questions, and (iii) a medical instrument score;
training a machine learning model hosted by the server, wherein training the machine learning model includes:
processing, by the machine learning model, the obtained data corresponding to the one or more medical instruments into a plurality of clusters, and
for each cluster, identifying, by the machine learning model, a subset of questions and corresponding answers, from the predetermined number of questions, that are uniquely associated with each cluster, and
generating, by the machine learning model, a dynamic question identification model based on the identified subset of questions for each cluster.

16. The computer-readable medium of claim 15, wherein training the machine learning model includes:
processing, by the machine learning model, the obtained data corresponding to each particular medical instrument of the one or more medical instruments into a plurality of clusters based on a medical instrument score that is associated with the particular medical instrument,
for each cluster, identifying, by the machine learning model, a subset of questions and corresponding answers, from the predetermined number of questions, that is uniquely associated with the particular cluster, and
iteratively performing, by the machine learning model, the processing and analyzing steps until a predetermined termination criterion is satisfied.

17. The computer-readable medium of claim 16, wherein the predetermined termination criterion is satisfied when each cluster of the plurality of clusters include a number of medical instruments that exceeds a minimum threshold number of medical instruments.

18. The computer-readable medium of claim 15, wherein training the machine learning model includes:
processing, by the machine learning model, the obtained data corresponding to each particular medical instrument of the one or more medical instruments into a plurality of clusters based on a medical instrument score associated with a second medical instrument that is related to the particular medical instrument,
for each cluster, identifying a subset of questions and corresponding answers, from the predetermined number of questions and corresponding answers associated with the one or more medical instruments that is uniquely associated with the particular cluster, and
iteratively performing, by the machine learning model, the processing and analyzing steps until a predetermined termination criterion is satisfied.

19. The computer-readable medium of claim 15, wherein generating a dynamic question identification model based on the identified subset of questions for each class includes generating a hierarchical decision tree.

20. The computer-readable medium of claim 19,
wherein the hierarchical decision tree includes at least one path from a root node to a leaf node for each cluster of the plurality of clusters,
wherein each path includes one or more intervening nodes, wherein the root node and each intervening node are each associated with a question,
wherein each leaf node is associated with a particular cluster.
